(19) United States
(12) Patent Application Publication
(10) Pub. No.: US 2025/0214552 A1
(43) Pub. Date: Jul. 3, 2025

(54) HYDRAULIC PRESSURE CONTROL UNIT AND STRADDLE-TYPE VEHICLE

(71) Applicant: Robert Bosch GmbH, Stuttgart (DE)

(72) Inventor: Hiroaki Atsushi, Kanagawa (JP)

(21) Appl. No.: 18/852,964

(22) PCT Filed: Mar. 28, 2023
(86) PCT No.: PCT/IB2023/053076

§ 371 Date: Sep. 30, 2024

(30) Foreign Application Priority Data
Apr. 11, 2022 (JP) 2022-064868

(51) Int. Cl. B60T 13/14; B60T 13/68; B60T 13/74; B62L 3/02

(52) U.S. Cl. CPC B60T 13/148; B60T 13/142; B60T 13/686; B60T 13/745; B62L 3/023

(57) ABSTRACT

To obtain a hydraulic pressure control unit for a straddle-type vehicle, downsizing of the hydraulic pressure control unit being enabled.

The hydraulic pressure control unit according to the invention is a hydraulic pressure control unit for a brake system mounted to the straddle-type vehicle, and includes: a base body formed with a brake fluid channel; a gear pump applying a pressure to a brake fluid in the channel; a motor as a drive source of the gear pump; and a hydraulic pressure regulation valve opening/closing the channel. The motor and the hydraulic pressure regulation valve are provided to the same side surface of the base body.

### BACKGROUND

The present invention relates to a hydraulic pressure control unit for a straddle-type vehicle and a straddle-type vehicle including the hydraulic pressure control unit.

A conventional vehicle includes a hydraulic pressure control unit that controls a pressure of a brake fluid in a hydraulic circuit filled with the brake fluid. For example, in a state where a vehicle occupant is operating an input section such as a brake lever, the hydraulic pressure control unit executes anti-lock brake control by increasing/reducing the pressure of the brake fluid in the hydraulic circuit to regulate a braking force generated on a wheel. In such a hydraulic pressure control unit, a channel that constitutes a part of the hydraulic circuit, a pump that applies the pressure to the brake fluid in the channel, a motor as a drive source of the pump, a hydraulic pressure regulation valve that opens/closes the channel, and the like are unitized (for example, see JP2014-015077A).

More specifically, the conventional unitized hydraulic pressure control unit includes: a base body that is formed with the brake fluid channel; a piston pump that applies the pressure to the brake fluid in the channel; the motor as the drive source of the pump; and the hydraulic pressure regulation valve that opens/closes the channel. The motor is provided to one side surface of the base body of the hydraulic pressure control unit. Meanwhile, the hydraulic pressure regulation valve is provided to a side surface among side surfaces of the base body. Such a side surface is an opposite surface from the side surface provided with the motor. That is, in the conventional hydraulic pressure control unit, the motor and the hydraulic pressure regulation valve are projected to mutually opposite directions with the base body being a reference.

### SUMMARY

A degree of freedom in a component layout and a degree of freedom in mountability of the hydraulic pressure control unit are lower for the straddle-type vehicle as one type of the vehicle than for the vehicle such as a four-wheeled motor vehicle. For such a reason, a demand for downsizing of the hydraulic pressure control unit, which is mounted to the straddle-type vehicle, has been increasing.

The invention has been made with the above-described problem as the background and therefore has a first purpose of obtaining a hydraulic pressure control unit for a straddle-type vehicle, downsizing of the hydraulic pressure control unit being enabled. The invention has a second purpose of obtaining a straddle-type vehicle that includes such a brake hydraulic pressure control unit.

A hydraulic pressure control unit according to the invention is a hydraulic pressure control unit for a brake system mounted to a straddle-type vehicle and includes: a base body formed with a brake fluid channel; a gear pump that applies a pressure to a brake fluid in the channel; a motor as a drive source of the gear pump; and a hydraulic pressure regulation valve that opens/closes the channel. The motor and the hydraulic pressure regulation valve are provided to the same side surface of the base body.

A straddle-type vehicle according to the invention includes the hydraulic pressure control unit according to the invention.

In the hydraulic pressure control unit according to the invention, the gear pump is used as a pump that applies the pressure to the brake fluid in the channel. Compared to a case where a piston pump is used as the pump that applies the pressure to the brake fluid in the channel, torque required by the motor for driving the pump is low when the gear pump is used as the pump that applies the pressure to the brake fluid in the channel. In other words, in the hydraulic pressure control unit according to the invention, a small-sized motor can be used as the drive source of the pump when compared to a hydraulic pressure control unit in which the piston pump is used as the pump that applies the pressure to the brake fluid in the channel. In addition, in the hydraulic pressure control unit according to the invention, the motor and the hydraulic pressure regulation valve are provided to the same side surface of the base body. Accordingly, in the hydraulic pressure control unit according to the invention, a space on a side of the motor can be used as an installation space for the hydraulic pressure regulation valve. Therefore, the hydraulic pressure control unit according to the invention can be downsized.

Furthermore, in the hydraulic pressure control unit according to the invention, the small-sized motor can be used when compared to the hydraulic pressure control unit in which the piston pump is used as the pump that applies the pressure to the brake fluid in the channel. Thus, it is possible to cut cost of the motor. Therefore, with the hydraulic pressure control unit according to the invention, it is possible to exert a cost-cutting effect of the hydraulic pressure control unit in addition to a downsizing effect of the hydraulic pressure control unit.

### BRIEF DESCRIPTION OF DRAWINGS

FIG. 1 is a view illustrating a configuration of a straddle-type vehicle, to which a brake system provided with a hydraulic pressure control unit according to an embodiment of the invention is mounted.

FIG. 2 is a view illustrating a configuration of the brake system provided with the hydraulic pressure control unit according to the embodiment of the invention.

FIG. 3 is an exploded perspective view illustrating a part of the hydraulic pressure control unit according to the embodiment of the invention.

FIG. 4 is a cross-sectional view illustrating a structure around a motor in the hydraulic pressure control unit according to the embodiment of the invention.

### DETAILED DESCRIPTION

A description will hereinafter be made on a hydraulic pressure control unit and a straddle-type vehicle according to the invention with reference to the drawings.

The following description will be made on a case where the invention is adopted for a two-wheeled motor vehicle. However, the invention may be adopted for a straddle-type vehicle other than the two-wheeled motor vehicle. Examples of the straddle-type vehicle other than the two-wheeled motor vehicle are a three-wheeled motor vehicle that has at least one of an engine and an electric motor as a drive source, and an all-terrain vehicle. A further example of the straddle-type vehicle other than the two-wheeled motor vehicle is a pedal-driven vehicle. The pedal-driven vehicle means a vehicle in general that can travel forward on a road by a depression force applied to pedals. That is, the pedal-driven vehicles include a normal pedal-driven vehicle, an electrically-assisted pedal-driven vehicle, an electric pedal-driven vehicle, and the like. The two-wheeled motor vehicle or the three-wheeled motor vehicle means a so-called motorcycle, and the motorcycles include a bike, a scooter, an electric scooter, and the like.

A configuration, operation, and the like, which will be described below, merely constitute one example, and each of the hydraulic pressure control unit and the straddle-type vehicle according to the invention is not limited to a case with such a configuration, such operation, and the like. For example, a description will hereinafter be made on an example in which a pressure of a brake fluid in a hydraulic circuit that generates a braking force on a front wheel is controlled by the hydraulic pressure control unit. However, the invention is not limited thereto. For example, a pressure of a brake fluid in a hydraulic circuit that generates a braking force on a rear wheel may be controlled by the hydraulic pressure control unit. Further alternatively, for example, the pressure of the brake fluid in the hydraulic circuit that generates the braking force on the front wheel and the pressure of the brake fluid in the hydraulic circuit that generates the braking force on the rear wheel may be controlled by the different hydraulic pressure control units.

In the drawings, the same or similar members or portions will be denoted by the same reference sign or will not be denoted by a reference sign. In addition, a detailed structure will appropriately be illustrated in a simplified manner or will not be illustrated. Furthermore, an overlapping description will appropriately be simplified or will not be made.

### Embodiment

### <Configuration and Operation of Brake System for Straddle-Type Vehicle>

A description will be made on a configuration and operation of a brake system according to this embodiment.

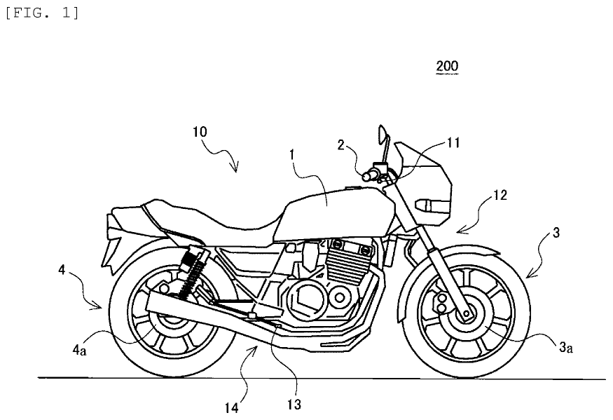

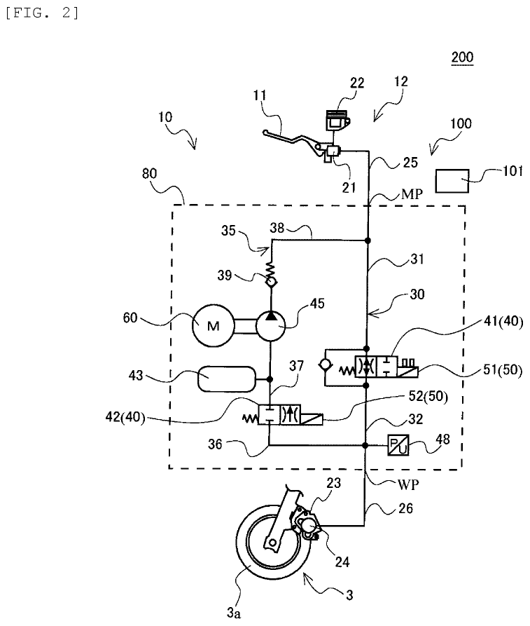

FIG. 1 is a view illustrating a configuration of a straddle-type vehicle, to which the brake system provided with a hydraulic pressure control unit according to the embodiment of the invention is mounted. FIG. 2 is a view illustrating a configuration of the brake system provided with the hydraulic pressure control unit according to the embodiment of the invention.

As illustrated in FIG. 1 and FIG. 2, a brake system 10 is mounted to a straddle-type vehicle 200 as a two-wheeled motor vehicle, for example. The straddle-type vehicle 200 includes: a trunk 1; a handlebar 2 that is held by the trunk 1 in a freely turnable manner; a front wheel 3 that is held by the trunk 1 in a freely turnable manner with the handlebar 2; and a rear wheel 4 that is held by the trunk 1 in a freely rotatable manner.

The brake system 10 includes a brake lever 11, a first hydraulic circuit 12 filled with a brake fluid, a brake pedal 13, and a second hydraulic circuit 14 filled with the brake fluid. That is, the brake system 10 includes two hydraulic circuits (the first hydraulic circuit 12 and the second hydraulic circuit 14). The brake lever 11 is provided to the handlebar 2 and is operated by a user's hand. The first hydraulic circuit 12 causes a rotor 3a, which rotates with the front wheel 3, to generate a braking force corresponding to an operation amount of the brake lever 11. The brake pedal 13 is provided to a lower portion of the trunk 1 and is operated by the user's foot. The second hydraulic circuit 14 causes a rotor 4a, which rotates with the rear wheel 4, to generate a braking force corresponding to an operation amount of the brake pedal 13.

Each of the brake lever 11 and the brake pedal 13 is an example of a brake input section. For example, as the brake input section that replaces the brake lever 11, a different brake pedal from the brake pedal 13, which is provided to the trunk 1, may be adopted. In addition, for example, as the brake input section that replaces the brake pedal 13, a different brake lever from the brake lever 11, which is provided to the handlebar 2, may be adopted. Furthermore, the first hydraulic circuit 12 may cause the rotor 4a, which rotates with the rear wheel 4, to generate the braking force corresponding to the operation amount of the brake lever 11 or an operation amount of the different brake pedal from the brake pedal 13, which is provided to the trunk 1. Moreover, the second hydraulic circuit 14 may cause the rotor 3a, which rotates with the front wheel 3, to generate the braking force corresponding to the operation amount of the brake pedal 13 or an operation amount of the different brake lever from the brake lever 11, which is provided to the handlebar 2.

In this embodiment, it is configured that a hydraulic pressure control unit 100 controls a pressure of the brake fluid in the first hydraulic circuit 12. Accordingly, a description will hereinafter be made on a configuration of the first hydraulic circuit 12 in the brake system 10.

The first hydraulic circuit 12 includes: a master cylinder 21 that includes a piston (not illustrated) therein; a reservoir 22 that is attached to the master cylinder 21; a brake caliper 23 that has a brake pad (not illustrated); and a wheel cylinder 24 that operates a brake pad (not illustrated) of the brake caliper 23.

A base body 80 of the hydraulic pressure control unit 100 provided to the first hydraulic circuit 12 is formed with a brake fluid channel. In this embodiment, as the brake fluid channels, a primary channel 30 and a secondary channel 35 are formed in the base body 80. The master cylinder 21 and the wheel cylinder 24 communicate with each other via a fluid pipe 25 connected between the master cylinder 21 and a master cylinder port MP formed in the base body 80, the primary channel 30 formed in the base body 80, and a fluid pipe 26 connected between the wheel cylinder 24 and a wheel cylinder port WP formed in the base body 80. The brake fluid in the wheel cylinder 24 is released to the primary channel 30 via the secondary channel 35. More specifically, as will be described below, the primary channel 30 includes a first primary channel 31 and a second primary channel 32. The brake fluid in the wheel cylinder 24 is released to the first primary channel 31 via the secondary channel 35.

The first hydraulic circuit 12 is provided with a hydraulic pressure regulation valve 40 that opens/closes the brake fluid channel. In this embodiment, the first hydraulic circuit 12 is provided with an inlet valve 41 and an outlet valve 42 as the hydraulic pressure regulation valves 40. Each of the inlet valve 41 and the outlet valve 42 opens/closes the brake fluid channel formed in the base body 80.

The inlet valve 41 is provided to the primary channel 30. In detail, the primary channel 30 includes the first primary channel 31 and the second primary channel 32. The first primary channel 31 communicates with the master cylinder port MP. The second primary channel 32 communicates with the wheel cylinder port WP. Then, the inlet valve 41 is provided between the first primary channel 31 and the second primary channel 32. A flow rate of the brake fluid between the first primary channel 31 and the second primary channel 32 is controlled by opening/closing operation of the inlet valve 41. The second primary channel 32 is provided with a hydraulic pressure sensor 48 that detects a pressure of the brake fluid in the wheel cylinder 24.

The outlet valve 42 is provided to the secondary channel 35. The secondary channel 35 is also provided with: an accumulator 43 that stores the brake fluid; and a gear pump 45 that applies a pressure to the brake fluid in the secondary channel 35. In detail, the secondary channel 35 includes a first secondary channel 36, a second secondary channel 37, and a third secondary channel 38. The first secondary channel 36 communicates with the second primary channel 32 of the primary channel 30. The third secondary channel 38 communicates with the first primary channel 31 of the primary channel 30. In the secondary channel 35, the second secondary channel 37 is a channel between the first secondary channel 36 and the third secondary channel 38. The outlet valve 42 is provided between the first secondary channel 36 and the second secondary channel 37. A flow rate of the brake fluid between the first secondary channel 36 and the second secondary channel 37 is controlled by opening/closing operation of the outlet valve 42. The accumulator 43 is provided to the second secondary channel 37. The gear pump 45 is provided between the second secondary channel 37 and the third secondary channel 38. This gear pump 45 is driven by a motor 60. That is, the motor 60 is a drive source of the gear pump 45. A check valve 39 is provided to the third secondary channel 38. The check valve 39 restricts a flow of the brake fluid from the master cylinder 21 into the gear pump 45 through the third secondary channel 38.

That is, the primary channel 30 communicates between the master cylinder port MP and the wheel cylinder port WP via the inlet valve 41. Meanwhile, the secondary channel 35 is a channel that is defined as a part or all of a channel from which the brake fluid in the wheel cylinder 24 is released to the master cylinder 21 via the outlet valve 42.

The hydraulic pressure regulation valve 40 is driven by a coil 50. In this embodiment, the first hydraulic circuit 12 is provided with, as the coils 50, an inlet valve coil 51 as a drive source of the inlet valve 41 and an outlet valve coil 52 as a drive source of the outlet valve 42. For example, when the inlet valve coil 51 is in an unenergized state, the inlet valve 41 allows a bidirectional flow of the brake fluid. Then, when the inlet valve coil 51 is energized, the inlet valve 41 is brought into a closed state and blocks the flow of the brake fluid. That is, in this embodiment, the inlet valve 41 is an electromagnetic valve that is opened when not energized. Meanwhile, for example, when the outlet valve coil 52 is in the unenergized state, the outlet valve 42 blocks the flow of the brake fluid. Then, when the outlet valve coil 52 is energized, the outlet valve 42 is brought into an open state and allows the flow of the brake fluid toward the accumulator 43. That is, in this embodiment, the outlet valve 42 is an electromagnetic valve that is closed when not energized.

The hydraulic pressure control unit 100 includes the base body 80, components (the accumulator 43, the hydraulic pressure regulation valves 40, the gear pump 45, the hydraulic pressure sensor 48, the coils 50, the motor 60, and the like) provided to the base body 80, and a controller (ECU) 101.

The controller 101 may be provided as a single unit or may be divided into plural units. The controller 101 may be attached to the base body 80 or may be attached to a member other than the base body 80. In addition, the controller 101 may partially or entirely be a microcomputer, a microprocessor unit, or the like, may be one whose firmware and the like can be updated, or may be a program module or the like that is executed by a command from a CPU or the like, for example.

For example, in a normal state, the controller 101 controls the inlet valve coil 51 and the outlet valve coil 52 in the unenergized state. When the brake lever 11 is operated in such a state, in the first hydraulic circuit 12, the piston (not illustrated) in the master cylinder 21 is pressed to increase the hydraulic pressure of the brake fluid in the wheel cylinder 24, the brake pad (not illustrated) of the brake caliper 23 is then pressed against the rotor 3a of the front wheel 3, and the front wheel 3 is thereby braked.

The controller 101 receives output of each of the sensors (the hydraulic pressure sensor 48, a wheel rotational frequency sensor, an acceleration sensor, and the like). In response to those types of the output, the controller 101 outputs a command that governs operation of the motor 60, each of the valves, and the like, and executes anti-lock brake control or the like.

For example, in the case where the pressure of the brake fluid in the wheel cylinder 24 of the first hydraulic circuit 12 is excessive or is possibly excessive, the controller 101 performs operation to reduce the pressure of the brake fluid in the wheel cylinder 24 of the first hydraulic circuit 12. At the time, the controller 101 drives the motor 60 in the first hydraulic circuit 12 while controlling the inlet valve coil 51 to be in an energized state and controlling the outlet valve coil 52 to be in the energized state. By driving the motor 60, the gear pump 45 applies, to the brake fluid in the secondary channel 35, a pressure in a direction in which the brake fluid flows from the second secondary channel 37 to the third secondary channel 38. In this way, the brake fluid flows from the second primary channel 32 of the primary channel 30 into the secondary channel 35. Then, the brake fluid that has flowed from the second primary channel 32 of the primary channel 30 into the secondary channel 35 is stored in the accumulator 43. In this way, the hydraulic pressure control unit 100 can reduce the pressure of the brake fluid in the wheel cylinder 24 of the first hydraulic circuit 12 and can thereby execute the anti-lock brake control for the first hydraulic circuit 12.

### <Configuration of Hydraulic Pressure Control Unit>

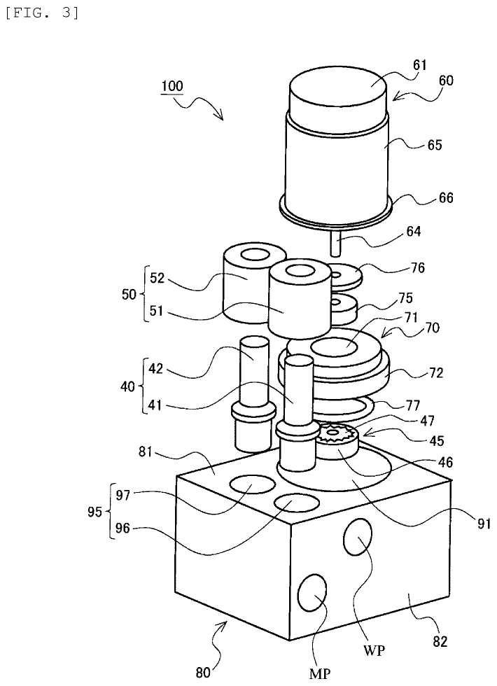

FIG. 3 is an exploded perspective view illustrating a part of the hydraulic pressure control unit according to the embodiment of the invention.

The base body 80 is formed of metal such as an aluminum alloy and has a substantially rectangular-parallelepiped shape, for example. In the hydraulic pressure control unit 100 according to this embodiment, the motor 60 and the hydraulic pressure regulation valve 40 are provided to a side surface 81 as one of side surfaces of the base body 80. That is, the motor 60 and the hydraulic pressure regulation valve 40 are provided to the same side surface 81 of the base body 80. Each of the side surfaces of the base body 80 may be flat, may include a curved portion, or may include a step.

In the conventional hydraulic pressure control unit, the hydraulic pressure regulation valve is provided to the side surface among the side surfaces of the base body. Such a side surface is the opposite surface from the side surface provided with the motor. That is, in the conventional hydraulic pressure control unit, the motor and the hydraulic pressure regulation valve are projected to the mutually opposite directions with the base body being the reference. For this reason, downsizing of the conventional hydraulic pressure control unit is difficult. Meanwhile, in the hydraulic pressure control unit 100 according to this embodiment, the motor 60 and the hydraulic pressure regulation valve 40 are provided to the same side surface 81 of the base body 80. Accordingly, in the hydraulic pressure control unit 100 according to this embodiment, a space on a side of the motor 60 can be used as an installation space for the hydraulic pressure regulation valve 40. Therefore, it is possible to downsize the hydraulic pressure control unit 100 according to this embodiment.

The base body 80 is formed with the master cylinder port MP and the wheel cylinder port WP. The master cylinder port MP and the wheel cylinder port WP are formed in a side surface 82 that leads to the side surface 81, for example. As described above, the master cylinder port MP communicates with the primary channel 30, and the fluid pipe 25, which communicates with the master cylinder 21, is connected to the master cylinder port MP. The wheel cylinder port WP communicates with the primary channel 30, and the fluid pipe 26, which communicates with the wheel cylinder 24, is connected to the wheel cylinder port WP. As illustrated in FIG. 2, the base body 80 is only formed with the brake fluid channel for the single hydraulic circuit (the first hydraulic circuit 12). Thus, as illustrated in FIG. 3, the base body 80 is formed with the only one master cylinder port MP and the only one wheel cylinder port WP.

Here, in the hydraulic pressure control unit 100 according to this embodiment, the hydraulic pressure regulation valve 40 is provided to the side surface 81 of the base body 80 as follows. As illustrated in FIG. 3, the base body 80 is formed with a hydraulic pressure regulation valve recess 95 that is opened to the side surface 81. The hydraulic pressure regulation valve recess 95 communicates with the brake fluid channel formed in the base body 80. Then, the hydraulic pressure regulation valve 40 is provided to the hydraulic pressure regulation valve recess 95 that is opened to the side surface 81. When a valve body reciprocates in the hydraulic pressure regulation valve 40, the brake fluid channel, which is formed in the base body 80, is opened/closed.

More specifically, as described above, the hydraulic pressure control unit 100 according to this embodiment includes the inlet valve 41 and the outlet valve 42 as the hydraulic pressure regulation valves 40. Thus, the base body 80 is formed with, as the hydraulic pressure regulation valve recesses 95, an inlet valve recess 96, to which the inlet valve 41 is provided, and an outlet valve recess 97, to which the outlet valve 42 is provided.

Of the brake fluid channels formed in the base body 80, the first primary channel 31 and the second primary channel 32 illustrated in FIG. 2 communicate with the inlet valve recess 96. When the valve body reciprocates in the inlet valve 41, a portion between the first primary channel 31 and the second primary channel 32 is opened/closed. In the state where the inlet valve 41 is provided to the inlet valve recess 96, the inlet valve 41 is partially projected to outside of the base body 80 from an opening of the inlet valve recess 96. The inlet valve coil 51 as the drive source of the inlet valve 41 is provided to the side surface 81 of the base body 80 in a manner to surround a portion of the inlet valve 41 that is projected to the outside of the base body 80.

Of the brake fluid channels formed in the base body 80, the first secondary channel 36 and the second secondary channel 37 illustrated in FIG. 2 communicate with the outlet valve recess 97. When the valve body reciprocates in the outlet valve 42, a portion between the first secondary channel 36 and the second secondary channel 37 is opened/closed. In the state where the outlet valve 42 is provided to the outlet valve recess 97, the outlet valve 42 is partially projected to the outside of the base body 80 from an opening of the outlet valve recess 97. The outlet valve coil 52 as the drive source of the outlet valve 42 is provided to the side surface 81 of the base body 80 in a manner to surround a portion of the outlet valve 42 that is projected to the outside of the base body 80.

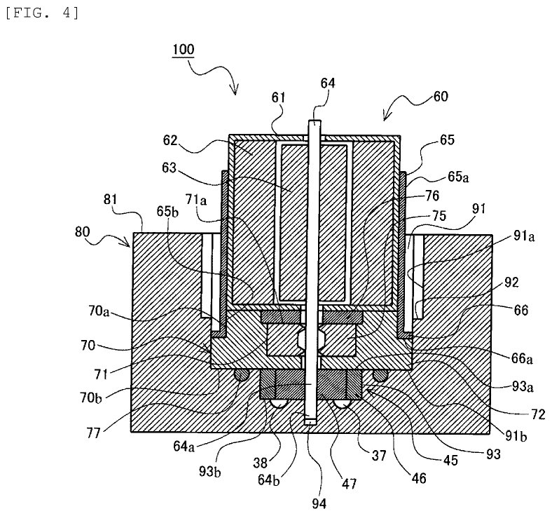

Here, in the hydraulic pressure control unit 100 according to this embodiment, the motor 60 is provided to the side surface 81 of the base body 80 as follows. A description will hereinafter be made on a configuration to attach the motor 60 to the base body 80 with reference to FIG. 3 and FIG. 4, which will be described below. In addition, a description will hereinafter be made on a configuration around the motor 60 in the hydraulic pressure control unit 100.

FIG. 4 is a cross-sectional view illustrating a structure around the motor in the hydraulic pressure control unit according to the embodiment of the invention. FIG. 4 is a cross-sectional view that is taken along an axial direction of a drive shaft 64 of the motor 60.

The motor 60 has an electric section 61. This electric section 61 includes a stator 62 and a rotor 63. The stator 62 is formed with a substantially cylindrical through-hole. The rotor 63 has a substantially cylindrical shape and is arranged in the through-hole of the stator 62 in a freely rotatable manner with respect to the stator 62. When the controller 101 controls an unillustrated coil of the stator 62 to be in the energized state, a current flows through the coil, and a magnetic field is generated. This magnetic field acts on the rotor 63, and the rotor 63 thereby rotates.

The motor 60 also includes the drive shaft 64. The drive shaft 64 is fixed to the rotor 63 and transmits drive power of the electric section 61 to one of gears constituting the gear pump 45. Here, in the conventional hydraulic pressure control unit, the piston pump is used as the pump that applies the pressure to the brake fluid. Meanwhile, in the hydraulic pressure control unit 100 according to this embodiment, the gear pump 45 is used as the pump that applies the pressure to the brake fluid. Compared to the case where the piston pump is used as the pump that applies the pressure to the brake fluid, torque required by the motor for driving the pump is low when the gear pump 45 is used as the pump that applies the pressure to the brake fluid. That is, compared to the conventional hydraulic pressure control unit, in the hydraulic pressure control unit 100 according to this embodiment, a small-sized motor can be used as the motor 60 that serves as the drive source of the pump. Accordingly, since the gear pump 45 is used as the pump that applies the pressure to the brake fluid in the hydraulic pressure control unit 100 according to this embodiment, it is possible to further downsize the hydraulic pressure control unit 100. In addition, compared to the conventional hydraulic pressure control unit, the small-sized motor 60 can be used in the hydraulic pressure control unit 100 according to this embodiment. Thus, it is possible to cut cost of the motor 60. Therefore, in addition to a downsizing effect, a cost-cutting effect can be exerted by the hydraulic pressure control unit 100 according to this embodiment.

In this embodiment, the motor 60 that is configured as described above is provided to the side surface 81 of the base body 80 as follows. The motor 60 has a motor cover 65 that is provided on an outer side of the electric section 61. The motor cover 65 has a substantially cylindrical shape, for example. The motor cover 65 includes a motor cover flange 66 that is projected outward from an outer circumferential surface 65a of the motor cover 65. Meanwhile, the base body 80 is formed with a motor recess 91 which is opened to the side surface 81 and in which at least a part of the motor 60 is accommodated. In addition, an inner circumferential surface 91a of the motor recess 91 is formed with a plastically deformed section 92. The plastically deformed section 92 according to this embodiment is a step that shifts the inner circumferential surface 91a of the motor recess 91 in a direction away from the outer circumferential surface 65a of the motor cover 65. For example, the plastically deformed section 92 is arranged to the inner circumferential surface 91a of the motor recess 91 at 90° intervals.

In the case where the motor 60 is fixed to the base body 80, the motor 60 is inserted in the motor recess 91. Then, in this state, a jig is inserted from above in a space on an outer circumferential side of the motor cover 65 in the motor recess 91, and the jig plastically deforms an upper surface of the plastically deformed section 92 by applying a pressure thereto. As a result, the plastically deformed section 92 is deformed in a manner to cover a part of an upper surface of the motor cover flange 66, that is, a part of an end surface of the motor cover flange 66 on the opening side of the motor recess 91. In this way, the motor cover flange 66 of the motor cover 65 is held between the plastically deformed section 92, which is formed on the inner circumferential surface 91a of the motor recess 91, and a bottom section 91b of the motor recess 91, and the motor 60 is thereby fixed to the base body 80. The motor 60 is fixed to the base body 80 by caulking, just as described. Accordingly, compared to a case where the motor 60 is bolted to the base body 80, a bolt for fixing the motor 60 is unnecessary. Thus, it is also unnecessary to form a female screw, in which the bolt is threaded, to the base body 80. Therefore, it is possible to further downsize the hydraulic pressure control unit 100 by fixing the motor 60 to the base body 80 by caulking, just as described.

Here, the motor cover flange 66 may directly or indirectly be held between the plastically deformed section 92 and the bottom section 91b of the motor recess 91. A state where the motor cover flange 66 is directly held between the plastically deformed section 92 and the bottom section 91b means a state where only the motor cover flange 66 is held between the plastically deformed section 92 and the bottom section 91b. Meanwhile, a state where the motor cover flange 66 is indirectly held between the plastically deformed section 92 and the bottom section 91b means a state where the motor cover flange 66 and another component are held between the plastically deformed section 92 and the bottom section 91b.

By the way, as the gear pump, an external gear pump and an internal gear pump are available. The internal gear pump is also referred to as a trochoidal pump. The external gear pump is a gear pump in which two intermeshing external gears rotate in a casing. The trochoidal pump is a gear pump in which an inner gear with external teeth meshing with an outer gear with internal teeth rotates in the outer gear. In this embodiment, the trochoidal pump is used as the gear pump 45. More specifically, the gear pump 45 includes: an outer rotor 46 as the outer gear; and an inner rotor 47 as the inner gear. The trochoidal pump is smaller than the external gear pump. Accordingly, it is possible to further downsize the hydraulic pressure control unit 100 by using the trochoidal pump as the gear pump 45.

In the case where the gear pump 45 is the trochoidal pump, the drive shaft 64 of the motor 60 is connected to the inner rotor 47. Then, when the rotor 63 rotates in the electric section 61 of the motor 60, the drive shaft 64, which is fixed to the rotor 63, rotates. In this way, the inner rotor 47, which is connected to the drive shaft 64, and the outer rotor 46, which meshes with the inner rotor 47, rotate, and the pressure is applied to the brake fluid existing between the inner rotor 47 and the outer rotor 46.

At this time, some of the brake fluid, to which the pressure has been applied between the inner rotor 47 and the outer rotor 46, attempts to partially leak out toward the electric section 61 along the drive shaft 64 of the motor 60. For this reason, the hydraulic pressure control unit 100 according to this embodiment includes a seal ring 75 and a support block 70. The support block 70 is arranged between the electric section 61 of the motor 60 and the gear pump 45 to hold the seal ring 75. The support block 70 has a substantially cylindrical shape, for example. The drive shaft 64 of the motor 60 is inserted in the seal ring 75, and the seal ring 75 seals an outer circumference of the drive shaft 64. Since the seal ring 75 and the support block 70 are provided, it is possible to suppress some of the brake fluid, to which the pressure has been applied between the inner rotor 47 and the outer rotor 46, from leaking out toward the electric section 61. In other words, since the seal ring 75 and the support block 70 are provided, it is possible to suppress the brake fluid from leaking out of the first hydraulic circuit 12 from the secondary channel 35. Thus, it is possible to improve accuracy of control for the pressure of the brake fluid in the wheel cylinder 24 by providing the seal ring 75 and the support block 70.

In addition, in the hydraulic pressure control unit 100 according to this embodiment, the seal ring 75 is held by the support block 70 as follows. The support block 70 is formed with a seal ring recess 71 that is opened toward the electric section 61 of the motor 60, for example. The seal ring 75 is at least partially fitted to the seal ring recess 71. In this way, the seal ring 75 is held by the support block 70. In the case where the seal ring 75 is held by the support block 70, just as described, there is a possibility that the seal ring 75 is pushed by the brake fluid, which flows from the gear pump 45 toward the seal ring 75, and is thereby pushed out of the seal ring recess 71. For this reason, the hydraulic pressure control unit 100 according to this embodiment includes a presser plate 76 that presses the seal ring 75 from an opening 71a side of the seal ring recess 71.

In addition, the presser plate 76 is held between the motor 60 and the support block 70. The presser plate 76 is fixed, just as described. Thus, the presser plate 76 can be fixed by assembling the motor 60 and the support block 70. Accordingly, when the presser plate 76 is fixed, just as described, it is possible to reduce man-hours for, for example, bolting the presser plate 76 to the support block 70 and thus to reduce assembly man-hours for the hydraulic pressure control unit 100. As a result, it is possible to further cut the cost of the hydraulic pressure control unit 100.

In the hydraulic pressure control unit 100 according to this embodiment, an outer circumferential surface 70a of the support block 70 is fitted to an inner circumferential surface 65b of the motor cover 65. With such a configuration, the support block 70 is inserted in the motor cover 65, and the outer circumferential surface 70a of the support block 70 is fitted to the inner circumferential surface 65b of the motor cover 65. In this way, the drive shaft 64 of the motor 60 and the seal ring 75 can be aligned. Therefore, with such a configuration, the drive shaft 64 of the motor 60 and the seal ring 75 can easily be aligned.

In order to improve reliability of the suppression of the brake fluid leakage by the seal ring 75, it is important to align an axis of the drive shaft 64 with a center of the seal ring 75 as accurately as possible. At this time, by adopting the configuration that the outer circumferential surface 70a of the support block 70 is fitted to the inner circumferential surface 65b of the motor cover 65, the support block 70 is the only one component that is interposed between the motor 60 and the seal ring 75 for the alignment of the drive shaft 64 and the seal ring 75. Accordingly, by adopting the configuration that the outer circumferential surface 70a of the support block 70 is fitted to the inner circumferential surface 65b of the motor cover 65, positioning accuracy of the seal ring 75 with respect to the drive shaft 64 is improved. As a result, the reliability of the suppression of the brake fluid leakage by the seal ring 75 is improved.

In the hydraulic pressure control unit 100 according to this embodiment, the support block 70 includes a support block flange 72 that is projected outward from the outer circumferential surface 70a of the support block 70. The support block flange 72 opposes an end surface 66a of the motor cover flange 66 of the motor cover 65. The end surface 66a is located on a bottom section 91b side of the motor recess 91. In the hydraulic pressure control unit 100 according to this embodiment, the motor cover flange 66 and the support block flange 72 are held between the plastically deformed section 92 and the bottom section 91b of the motor recess 91. In this way, the motor 60 and the support block 70 are fixed to the base body 80. With such a configuration, it is possible to fix both of the motor 60 and the support block 70 to the base body 80 by single caulking work, and it is thus possible to reduce the assembly man-hours for the hydraulic pressure control unit 100. As a result, it is possible to further cut the cost of the hydraulic pressure control unit 100.

In the hydraulic pressure control unit 100 according to this embodiment, a pump recess 93 is formed in the bottom section 91b of the motor recess 91 in the base body 80. The second secondary channel 37 and the third secondary channel 38 communicate with this pump recess 93. The gear pump 45 is accommodated in the pump recess 93. In this way, the gear pump 45 is provided between the second secondary channel 37 and the third secondary channel 38. In addition, in the hydraulic pressure control unit 100 according to this embodiment, a lower surface 70b of the support block 70 is in contact with the bottom section 91b of the motor recess 91 and covers an opening 93a of the pump recess 93.

In the case where the lower surface 70b of the support block 70 is brought into contact with the bottom section 91b of the motor recess 91, an installation angle of the drive shaft 64 of the motor 60 is affected by a degree of flatness of the lower surface 70b of the support block 70. Thus, the degree of flatness of the lower surface 70b of the support block 70 is preferably high. Meanwhile, in order to suppress the leakage of the brake fluid, to which the pressure has been applied by the gear pump 45, out of the gear pump 45, it is important to consider a clearance between the gear pump 45 and the component for covering the opening 93a of the pump recess 93. More specifically, within a rotatable range of the outer rotor 46 and the inner rotor 47, the clearance between the gear pump 45 and the component for covering the opening 93a of the pump recess 93 is preferably as small as possible. For this reason, a degree of flatness of the component for covering the opening 93a of the pump recess 93 is preferably high.

Here, by adopting the configuration that the lower surface 70b of the support block 70 is brought into contact with the bottom section 91b of the motor recess 91 and covers the opening 93a of the pump recess 93, it is possible to use the lower surface 70b, which is processed to have the high degree of flatness, in the support block 70 as the component for covering the opening 93a of the pump recess 93. In this way, the components, each of which is requested to have the high degree of flatness, can be consolidated, and consequently, the number of the components is reduced. Therefore, it is possible to further cut the cost of the hydraulic pressure control unit 100. In addition, in the hydraulic pressure control unit 100 according to this embodiment, an O-ring 77 is provided between the lower surface 70b of the support block 70 and the bottom section 91b of the motor recess 91. Therefore, it is possible with the O-ring 77 to prevent the leakage of the brake fluid to the outside of the first hydraulic circuit 12 from the portion between the lower surface 70b of the support block 70 and the bottom section 91b of the motor recess 91.

In the hydraulic pressure control unit 100 according to this embodiment, a drive shaft recess 94 is formed in the bottom section 93b of the pump recess 93. Then, in the drive shaft 64 of the motor 60, an intermediate section 64a is connected to one (the inner rotor 47 in this embodiment) of the gears constituting the gear pump 45, and a tip 64b is inserted in a freely rotatable manner in the drive shaft recess 94. The brake fluid flows into the drive shaft recess 94 that is formed in the bottom section 93b of the pump recess 93. Consequently, the drive shaft recess 94 can function as a plain bearing that supports the tip 64b of the drive shaft 64 in the motor 60 in a freely rotatable manner by using the brake fluid as a lubricant. Thus, a ball bearing for supporting the tip 64b of the drive shaft 64 is unnecessary when the tip 64b of the drive shaft 64 is inserted in the freely rotatable manner in the drive shaft recess 94, which is formed in the bottom section 93b of the pump recess 93. Therefore, it is possible to further downsize the hydraulic pressure control unit 100 and further cut the cost thereof by inserting the tip 64b of the drive shaft 64 in the freely rotatable manner in the drive shaft recess 94, which is formed in the bottom section 93b of the pump recess 93.

### <Effects of Hydraulic Pressure Control Unit>

A description will be made on effects of the hydraulic pressure control unit 100 according to this embodiment.

The hydraulic pressure control unit 100 according to this embodiment is the hydraulic pressure control unit for the brake system 10 that is mounted to the straddle-type vehicle 200. The hydraulic pressure control unit 100 includes: the base body 80 that is formed with the brake fluid channel; the gear pump 45 that applies the pressure to the brake fluid in the channel; the motor 60 as the drive source of the gear pump 45; and the hydraulic pressure regulation valve 40 that opens/closes the channel. The motor 60 and the hydraulic pressure regulation valve 40 are provided to the same side surface 81 of the base body 80.

In the thus-configured hydraulic pressure control unit 100, the gear pump 45 is used as the pump that applies the pressure to the brake fluid in the channel. Compared to the case where the piston pump is used as the pump that applies the pressure to the brake fluid in the channel, the torque required by the motor 60 for driving the pump is low when the gear pump 45 is used as the pump that applies the pressure to the brake fluid in the channel. In other words, in the thus-configured hydraulic pressure control unit 100, the small-sized motor 60 can be used when compared to the hydraulic pressure control unit in which the piston pump is used as the pump that applies the pressure to the brake fluid in the channel. In addition, in the thus-configured hydraulic pressure control unit 100, the motor 60 and the hydraulic pressure regulation valve 40 are provided to the same side surface 81 of the base body 80. Accordingly, in the thus-configured hydraulic pressure control unit 100, the space on the side of the motor 60 can be used as the installation space for the hydraulic pressure regulation valve 40. Therefore, it is possible to downsize the thus-configured hydraulic pressure control unit 100. Furthermore, in the thus-configured hydraulic pressure control unit 100, the small-sized motor 60 can be used when compared to the hydraulic pressure control unit in which the piston pump is used as the pump that applies the pressure to the brake fluid in the channel. Thus, it is possible to cut the cost of the motor 60. Therefore, with the thus-configured hydraulic pressure control unit 100, it is possible to exert the cost-cutting effect of the hydraulic pressure control unit 100 in addition to the downsizing effect of the hydraulic pressure control unit 100.

Preferably, the gear pump 45 is the trochoidal pump. It is possible to downsize the thus-configured hydraulic pressure control unit 100.

Preferably, the motor 60 includes: the electric section 61 that has the rotor 63; and the drive shaft 64 that is fixed to the rotor 63 and transmits the drive power of the electric section 61 to one of the gears constituting the gear pump 45. In addition, the hydraulic pressure control unit 100 includes: the seal ring 75 in which the drive shaft 64 is inserted; and the support block 70 that is arranged between the electric section 61 and the gear pump 45 and holds the seal ring 75. In the thus-configured hydraulic pressure control unit 100, it is possible to suppress the leakage of the brake fluid from the secondary channel 35 to the outside of the first hydraulic circuit 12 and thus to improve the accuracy of the control for the pressure of the brake fluid in the wheel cylinder 24.

Preferably, the support block 70 is formed with the seal ring recess 71, to which at least a part of the seal ring 75 is fitted. In addition, the hydraulic pressure control unit 100 includes the presser plate 76 that presses the seal ring 75 from the opening 71a side of the seal ring recess 71. The presser plate 76 is held between the motor 60 and the support block 70. It is possible to reduce the assembly man-hours for the thus-configured hydraulic pressure control unit 100 and thus to further cut the cost of the hydraulic pressure control unit 100.

Preferably, the motor 60 includes the motor cover 65 that is provided on the outer side of the electric section 61, and the outer circumferential surface 70a of the support block 70 is fitted to the inner circumferential surface 65b of the motor cover 65. In the thus-configured hydraulic pressure control unit 100, the drive shaft 64 of the motor 60 and the seal ring 75 can easily be aligned.

Preferably, the motor cover 65 includes the motor cover flange 66 that is projected outward from the outer circumferential surface 65a of the motor cover 65. In addition, the base body 80 is formed with the motor recess 91 in which at least a part of the motor 60 is accommodated, and the plastically deformed section 92 is formed on the inner circumferential surface 91a of the motor recess 91. Then, the motor cover flange 66 is directly or indirectly held between the plastically deformed section 92 and the bottom section 91b of the motor recess 91, and the motor 60 is thereby fixed to the base body 80. It is possible to downsize the thus-configured hydraulic pressure control unit 100.

Preferably, the support block 70 includes the support block flange 72 that is projected outward from the outer circumferential surface 70a of the support block 70 and opposes the end surface 66a, which is located on the bottom section 91b side of the motor recess 91, in the motor cover flange 66. The motor cover flange 66 and the support block flange 72 are held between the plastically deformed section 92 and the bottom section 91b of the motor recess 91. In this way, the motor 60 and the support block 70 are fixed to the base body 80. It is possible to reduce the assembly man-hours for the thus-configured hydraulic pressure control unit 100 and thus to further cut the cost of the hydraulic pressure control unit 100.

Preferably, the base body 80 is formed with the motor recess 91 in which at least a part of the motor 60 is accommodated, and the pump recess 93 is formed in the bottom section 91b of the motor recess 91 in the base body 80. The lower surface 70b of the support block 70 is brought into contact with the bottom section 91b of the motor recess 91 and covers the opening 93a of the pump recess 93. It is possible to reduce the number of the components of the thus-configured hydraulic pressure control unit 100 and thus to further cut the cost of the hydraulic pressure control unit 100.

Preferably, the base body 80 is formed with the motor recess 91 in which at least a part of the motor 60 is accommodated, the pump recess 93 is formed in the bottom section 91b of the motor recess 91 in the base body 80, and the drive shaft recess 94 is formed in the bottom section 93b of the pump recess 93. In the drive shaft 64 of the motor 60, the intermediate section 64a is connected to one of the gears constituting the gear pump 45, and the tip 64b is inserted in the freely rotatable manner in the drive shaft recess 94. In the thus-configured hydraulic pressure control unit 100, the ball bearing for supporting the tip 64b of the drive shaft 64 is unnecessary. Therefore, it is possible to further downsize the hydraulic pressure control unit 100 and to further cut the cost of the hydraulic pressure control unit 100.

The description has been made so far on the embodiment. However, the present invention is not limited to the description of the embodiment. For example, in the invention, the embodiment may only partially be implemented. Alternatively, for example, in the invention, the hydraulic pressure control unit may control the pressure of the brake fluid in the hydraulic circuit that generates the braking force on the rear wheel. Further alternatively, for example, the pressure of the brake fluid in the hydraulic circuit that generates the braking force on the front wheel and the pressure of the brake fluid in the hydraulic circuit that generates the braking force on the rear wheel may be controlled by the different hydraulic pressure control units.

### REFERENCE SIGNS LIST

1: Trunk
2: Handlebar
3: Front wheel
3a: Rotor
4: Rear wheel
4a: Rotor
10: Brake system
11: Brake lever
12: First hydraulic circuit
13: Brake pedal
14: Second hydraulic circuit
21: Master cylinder
22: Reservoir
23: Brake caliper
24: Wheel cylinder
25: Fluid pipe
26: Fluid pipe
30: Primary channel
31: First primary channel
32: Second primary channel
35: Secondary channel
36: First secondary channel
37: Second secondary channel
38: Third secondary channel
39: Check valve
40: Hydraulic pressure regulation valve
41: Inlet valve
42: Outlet valve
43: Accumulator
45: Gear pump
46: Outer rotor
47: Inner rotor
48: Hydraulic pressure sensor
50: Coil
51: Inlet valve coil
52: Outlet valve coil
60: Motor
61: Electric section
62: Stator
63: Rotor
64: Drive shaft
64a: Intermediate section
64b: Tip
65: Motor cover
65a: Outer circumferential surface
65b: Inner circumferential surface
66: Motor cover flange
66a: End surface
70: Support Block
70a: Outer circumferential surface
70b: Lower surface
71: Seal ring recess
71a: Opening
72: Support block flange
75: Seal ring
76: Presser plate
77: O-ring
80: Base body
81: Side surface
82: Side surface
91: Motor recess
91a: Inner circumferential surface
91b: Bottom section
92: Plastically deformed section
93: Pump recess
93a: Opening
93b: Bottom section
94: Drive shaft recess
95: Hydraulic pressure regulation valve recess
96: Inlet valve recess
97: Outlet valve recess
100: Hydraulic pressure control unit
101: Controller
200: Straddle-type vehicle
MP: Master cylinder port
WP: Wheel cylinder port

1. A hydraulic pressure control unit (100) for a brake system (10) mounted to a straddle-type vehicle (200), the hydraulic pressure control unit (100) comprising:
a base body (80) formed with a brake fluid channel (30, 35);
a gear pump (45) that applies a pressure to a brake fluid in the brake fluid channel (35);
a motor (60) as a drive source of the gear pump (45); and
a hydraulic pressure regulation valve (40) that opens/closes the brake fluid channel (30, 35), wherein
the motor (60) and the hydraulic pressure regulation valve (40) are provided to a same side surface (81) of the base body (80).

2. The hydraulic pressure control unit (100) according to claim 1, wherein
the gear pump (45) is a trochoidal pump.

3. The hydraulic pressure control unit (100) according to claim 2, wherein
the base body (80) is formed with: one master cylinder port (MP) which communicates with the brake fluid channel (30) and to which a fluid pipe (25) communicating with a master cylinder (21) is connected; and one wheel cylinder port (WP) which communicates with the brake fluid channel (30) and to which a fluid pipe (26) communicating with the wheel cylinder port (24) is connected.

4. The hydraulic pressure control unit (100) according to claim 1, wherein
the motor (60) includes: an electric section (61) that has a rotor (63); and a drive shaft (64) that is fixed to the rotor (63) and transmits drive power of the electric section (61) to one of a gear of the gear pump (45), and
the hydraulic pressure control unit (100) includes: a seal ring (75) in which the drive shaft (64) is inserted; and a support block (70) that is arranged between the electric section (61) and the gear pump (45) and holds the seal ring (75).

5. The hydraulic pressure control unit (100) according to claim 4, wherein
the support block (70) is formed with a seal ring recess (71), to which at least a part of the seal ring (75) is fitted,
the hydraulic pressure control unit (100) includes a presser plate (76) that presses the seal ring (75) from an opening (71a) side of the seal ring recess (71), and
the presser plate (76) is held between the motor (60) and the support block (70).

6. The hydraulic pressure control unit (100) according to claim 4, wherein
the motor (60) includes a motor cover (65) that is provided to an outer side of the electric section (61), and
an outer circumferential surface (70a) of the support block (70) is fitted to an inner circumferential surface (65b) of the motor cover (65).

7. The hydraulic pressure control unit (100) according to claim 6, wherein
the motor cover (65) includes a motor cover flange (66) that is projected outward from an outer circumferential surface (65a) of the motor cover (65),
the base body (80) is formed with a motor recess (91) in which at least a part of the motor (60) is accommodated,
an inner circumferential surface (91a) of the motor recess (91) is formed with a plastically deformed section (92), and
the motor cover flange (66) is directly or indirectly held between the plastically deformed section (92) and a bottom section (91b) of the motor recess (91), and the motor (60) is thereby fixed to the base body (80).

8. The hydraulic pressure control unit (100) according to claim 7, wherein
the support block (70) includes a support block flange (72) that is projected outward from the outer circumferential surface (70a) of the support block (70) and opposes an end surface (66a), which is located on a side of the bottom section (91b) of the motor recess (91), in the motor cover flange (66), and
the motor cover flange (66) and the support block flange (72) are held between the plastically deformed section (92) and the bottom section (91b) of the motor recess (91), and the motor (60) and the support block (70) are thereby fixed to the base body (80).

9. The hydraulic pressure control unit (100) according to claim 4, wherein the base body (80) is formed with a motor recess (91) in which at least a part of the motor (60) is accommodated,
a pump recess (93) in which the gear pump (45) is accommodated is formed in a bottom section (91b) of the motor recess (91), and
a lower surface (70b) of the support block (70) is in contact with the bottom section (91b) of the motor recess (91) and covers an opening (93a) of the pump recess (93).

10. The hydraulic pressure control unit (100) according to claim 4, wherein
the base body (80) is formed with a motor recess (91) in which at least a part of the motor (60) is accommodated,
a pump recess (93) in which the gear pump (45) is accommodated is formed in a bottom section (91b) of the motor recess (91),
a drive shaft recess (94) is formed in a bottom section (93b) of the pump recess (93), and
in the drive shaft (64), an intermediate section (64a) is connected to the gear, and a tip (64b) is inserted in a freely rotatable manner in the drive shaft recess (94).

11. A straddle-type vehicle (200) comprising:
the hydraulic pressure control unit (100) according to claim 1.
